(19) United States
(12) Patent Application Publication
(10) Pub. No.: US 2023/0417922 A1
(43) Pub. Date: Dec. 28, 2023

(54) RECEIVING DEVICE OF A DETECTION DEVICE FOR MONITORING AT LEAST ONE MONITORING REGION FOR OBJECTS, DETECTION DEVICE, VEHICLE COMPRISING AT LEAST ONE DETECTION DEVICE, AND METHOD FOR OPERATING A SELECTION DEVICE

(71) Applicant: Valeo Schalter und Sensoren GmbH, Bietigheim-Bissingen (DE)

(72) Inventors: Christoph Parl, Bietigheim-Bissingen (DE); Thomas Schuler, Bietigheim-Bissingen (DE); Wensi Zheng, Bietigheim-Bissingen (DE)

(73) Assignee: Valeo Schalter und Sensoren GmbH, Bietigheim-Bissingen (DE)

(21) Appl. No.: 18/275,526

(22) PCT Filed: Feb. 1, 2022
(86) PCT No.: PCT/EP2022/052254

§ 371 Date: Aug. 2, 2023

(30) Foreign Application Priority Data
Feb. 2, 2021 (DE) 10 2021 102 292.4

(51) Int. Cl. G01S 17/931; G01S 7/493; G01S 7/481

(52) U.S. Cl. CPC G01S 17/931; G01S 7/493; G01S 7/4816

(57) ABSTRACT

A receiving device of a detection device for monitoring a monitoring region for objects using electromagnetic scanning signals is disclosed. The device has a signal converting means for converting electromagnetic signals originating from electromagnetic scanning signals into electric signals and a frequency analyzing means for analyzing the frequency of signals. The frequency analyzing means has at least one spectral analyzing means, by which magnetic signals are analyzed to form at least one electromagnetic spectrum that is output in a spectrum output range of the at least one spectral analyzing means. At least two signal converting means, by which separate electric signals are ascertained, are assigned to different sections of a spectrum output range of the spectral analyzing means. The different sections of the spectrum output range correspond to different frequency ranges of an electromagnetic spectrum.

### TECHNICAL AREA

The invention relates to a receiving device of a detection device for monitoring at least one monitoring region for objects by means of electromagnetic scanning signals, comprising at least one signal converting means for converting electromagnetic signals originating from electromagnetic scanning signals into electrical signals, and comprising at least one frequency analyzing means for analyzing the frequency of signals.

The invention furthermore relates to a detection device for monitoring at least one monitoring region for objects by means of electromagnetic scanning signals,
comprising at least one emitting device for emitting electromagnetic scanning signals into at least one monitoring region,
comprising at least one receiving device, which includes at least one signal converting means for converting electromagnetic signals originating from electromagnetic scanning signals into electrical signals,
and at least one frequency analyzing means for analyzing the frequency of signals.

In addition, the invention relates to a vehicle comprising at least one detection device for monitoring at least one monitoring region for objects by means of electromagnetic scanning signals,
wherein the at least one detection device comprises at least one emitting device for emitting electromagnetic scanning signals into at least one monitoring region, and at least one receiving device,
wherein at least one receiving device includes at least one signal converting means for converting electromagnetic signals originating from electromagnetic scanning signals into electrical signals,
and at least one frequency analyzing means for analyzing the frequency of signals.

Furthermore, the invention relates to a method for operating a detection device for monitoring at least one monitoring region for objects,
in which at least one electromagnetic scanning signal is emitted into the at least one monitoring region using at least one emitting device,
electromagnetic echo signals from electromagnetic scanning signals reflected in the at least one monitoring region are converted using at least one signal converting means of a receiving device into electrical signals,
signals are subjected to a frequency analysis using at least one frequency analyzing means of the at least one receiving device.

### Prior Art

A high-resolution LiDAR system is known from US 2019/0370614 A1. A laser source emits a carrier wave that is amplitude-, frequency-, or phase-modulated in the modulator, or modulated in a combination, to generate a pulse that has a bandwidth and period. A splitter divides the chirp into a transmit beam with the majority of the beam energy and a reference beam with a much lower amount of energy, but which is sufficient to produce a good heterodyne or homodyne interference with the light scattered back from a target. Multiple parts of the target scatter a respective reflected light signal back to the detector array for each scanned beam, resulting in a point cloud based on the multiple distances of each of the multiple parts of the target that are illuminated by multiple beams and multiple return paths. A de-chirp mixer compares a detected signal to the original chirp wave-form output by the power splitter and operational amplifier in order to generate an electrical signal at the beat frequency that depends on the frequency difference between the RF reference waveform and the detected waveform. An additional operational amplifier and an FFT process are used to determine the beat frequency.

The invention is based on the object of designing a receiving device, a detection device, a vehicle, and a method of the type mentioned at the outset which can be implemented and/or operated with a lower expenditure.

### Disclosure of the Invention

This object is achieved according to the invention in the receiving device in that at least one frequency analyzing means includes at least one spectral analyzing means, using which electromagnetic signals can be analyzed to form at least one electromagnetic spectrum which can be output in at least one spectrum output region of the at least one spectral analyzing means,
at least two signal converting means, using which separate electrical signals can be ascertained, are assigned to different sections of at least one spectrum output region of the at least one spectral analyzing means,
wherein the different sections of at least one spectrum output region of the at least one spectral analyzing means correspond to different frequency ranges of at least one electromagnetic spectrum.

According to the invention, the at least one frequency analyzing means includes at least one spectral analyzing means, using which electromagnetic signals can be analyzed to form at least one electromagnetic spectrum, in particular a frequency spectrum. In this way, the spectral analysis can be performed directly on the electromagnetic level, in particular the optical level.

According to the invention, a transformation of the electromagnetic signals, in particular echo signals and/or scanning signals, into a frequency spectrum can be achieved in an optical manner. In contrast to a Fourier transform in an electrical manner, the optical transformation according to the invention can be implemented with lower losses. Furthermore, an expenditure for electrical components, which assume the conversion into the frequency spectrum in the LiDAR system known from the prior art, can be reduced.

Advantageously, electromagnetic echo signals and/or electromagnetic scanning signals can be analyzed to form at least one electromagnetic spectrum using the at least one frequency analyzing means. In this way, the electromagnetic echo signals and the electromagnetic scanning signals can be jointly processed, in particular brought into correlation.

The electromagnetic spectrum is output in at least one spectrum output region of the at least one spectral analyzing means. Different sections of the at least one spectrum output region correspond to different frequency ranges of the at least one electromagnetic spectrum here.

At least two signal converting means are assigned to different sections of the at least one spectrum output region. The corresponding different frequency ranges of the output spectrum can be detected separately using the signal converting means and converted into corresponding electrical signals.

The at least one spectrum output region can advantageously extend with respect to frequency over the possible frequencies of the electromagnetic scanning signals and the electromagnetic echo signals. In this way, the at least one spectrum output region completely covers the entire frequency range of the electromagnetic scanning signals and the echo signals.

The receiving device can advantageously include a plurality of signal converting means which are assigned to different sections along the at least one spectrum output region. In this way, a resolution in the detection of the at least one electromagnetic spectrum can be increased. A resolution in the determination of the distance of objects can thus be improved.

At least one electromagnetic scanning signal can advantageously be a frequency-modulated continuous wave signal (FMCW signal). The reflected echo signal is accordingly also a FMCW signal. Using a signal converting means, at a defined point in time, an electrical signal can be implemented which characterizes the signal strength of the corresponding section of the electromagnetic spectrum to which the signal converting means is assigned. If a spectral line lies in the section of the electromagnetic spectrum at the defined point in time, a corresponding signal maximum is thus generated using the signal converting means. A spectral line characterizes the presence of a frequency in the introduced electromagnetic signal. The frequency is characterized by the position of the spectral line in the at least one spectrum output region, in particular the section of the at least one spectrum output region in which the spectral line lies.

The receiving device can advantageously be implemented at least partially as a one-chip system. In one-chip systems, all or a large part of the functions of the system can be integrated on one chip. Such one-chip systems can be implemented in a space-saving and robust manner. One-chip systems are also known under the designation “system-on-a-chip”.

Using the receiving device according to the invention, with the aid of at least one frequency analysis, maxima can be extracted in a frequency spectrum of the electromagnetic signals, in particular the scanning signals and/or the echo signals.

On the basis of at least one frequency analysis, information about the at least one monitoring region, in particular object information of objects in the at least one monitoring region, can be determined. The information on the at least one monitoring region can be object information, in particular in the form of distances, velocities, and/or directions of objects, at which the scanning signals are reflected, relative to at least one reference region, in particular of the detection device.

The at least one detection device can advantageously be designed as light detection and ranging systems (LiDAR), laser detection and ranging systems (LaDAR), or the like. Using such detection devices, distances, velocities, and/or directions of objects relative to reference regions, in particular of the detection device, can be determined.

The invention can advantageously be used in vehicles, in particular motor vehicles. The invention can advantageously be used in land vehicles, in particular passenger vehicles, trucks, buses, motorcycles, or the like, air vehicles, in particular drones, and/or water vehicles. The invention may also be used in vehicles that may be operated autonomously or at least semiautonomously. However, the invention is not restricted to vehicles. It can also be used in a stationary scenario, in robotics and/or in machines, in particular construction or transport machinery, such as cranes, excavators or the like.

The detection device can advantageously be connected to at least one electronic control device of a vehicle or machine, in particular a driver assistance system, or can be part of such a control device. In this way, at least a part of the functions of the vehicle or the machine can be operated autonomously or partially autonomously.

Stationary or moving objects, in particular vehicles, persons, in particular gestures and/or movements, animals, plants, obstacles, roadway irregularities, in particular potholes or rocks, roadway boundaries, traffic signs, free spaces, in particular parking spaces, precipitation, or the like can be detected using the detection device.

In one advantageous embodiment, at least one spectral analyzing means can include at least one spectral apparatus. Electromagnetic signals can be decomposed into electromagnetic spectra using a spectral apparatus.

At least one spectral analyzing means can advantageously include at least one spectroscope. Spectroscopes can be implemented using simple means and/or in a space-saving manner.

At least one spectral analyzing means can advantageously be designed as an on-ship spectroscope. The at least one spectral analyzing means can be implemented in a space-saving manner in this way.

At least parts of at least one spectral analyzing means can advantageously be integrated on an optical semiconductor chip, for example a silicon optical chip (SoC). In other words, at least parts of the at least one spectral analyzing means can be integrated on a so-called photonic integrated circuit (PIC). In this way, the at least one spectral analyzing means can be implemented more compactly and robustly.

In a further advantageous embodiment, at least one signal converting means can include at least one electro-optical component, using which electromagnetic signals can be converted into electrical signals. In this way, the electromagnetic signals of the electromagnetic spectrum can be converted into electrical signals. The electrical signals can be further processed using corresponding electrical components.

At least one signal converting means can advantageously be implemented using sensors, in particular point sensors, line sensors, and/or surface sensors, especially (avalanche) photodiodes, photodiode lines, CCD sensors, active pixel sensors, in particular CMOS sensors, or the like. In this way, the signal converting means can be flexibly adapted to their intended use.

At least one signal converting means can advantageously be designed for the frequencies of the electromagnetic signals, in particular the scanning signals and/or the echo signals. In this way, the efficiency of the signal conversion and/or a signal-to-noise ratio can be improved.

In a further advantageous embodiment, at least one frequency analyzing means can include at least one recording control means, using which a respective recording starting time and/or a respective recording duration can be controlled for at least a part of the signal converting means. In this way, the electrical signals determined using the signal converting means can be corroborated with a time dimension. A frequency-time profile of the electromagnetic signals to be analyzed, in particular the scanning signals and/or echo signals, can thus be determined.

In a further advantageous embodiment, the receiving device can include at least one storage means for storing at least a part of the electrical signals determined using the signal converting means. In this way, the electrical signals can be stored. The transmission of the electrical signals, in particular to downstream digitizing means, can thus be slowed. An expenditure for digitizing means for digitizing the electrical signals can thus be reduced. In particular, a number of analog-to-digital converter channels for digitizing the electrical signals of the individual signal converting means can be reduced with the aid of the at least one electrical storage means.

The at least one storage means can advantageously include or consist of at least one analog storage cell. Analog electrical signals can be stored using analog storage cells.

The electrical storage means can advantageously be simultaneously filled and/or read. In this way, the electrical signals determined from the electromagnetic spectrum can be simultaneously stored and passed on. A snapshot of the electromagnetic spectrum can thus be processed by means of the electrical signals.

In a further advantageous embodiment, the receiving device can include at least one amplifying means for amplifying at least one part of the electrical signals determined using the signal converting means. A power consumption of the electrical components of the receiving device can be reduced in this way.

At least one amplifying means can advantageously include or consist of a preamplifier, in particular a trans-impedance amplifier (TIA), having low bandwidth. The power consumption of the electrical components can thus be reduced further.

Advantageously, at least one amplifying means can optionally be arranged between a signal converting means and a storage means. In this way, the electrical signals can be amplified before they are stored in the storage means.

Alternatively or additionally, at least one amplifying means can be functionally arranged between a storage means and a digitizing means. In this way, the electrical signal stored in the storage means can be amplified before the digitizing using the digitizing means. Overall, a signal-to-noise ratio can thus be improved.

In a further advantageous embodiment, the receiving device can include at least one digitizing means for digitizing at least a part of the electrical signals determined using the signal converting means. In this way, the analog electrical signals can be converted into digital signals. The digital signals can be processed using corresponding electrical digital components.

At least one digitizing means can advantageously include at least one analog-to-digital converter. The digitizing can be implemented easily in this way.

At least one digitizing means can advantageously be functionally arranged after at least one storage means. In this way, an expenditure for digitizing means, in particular the number of required analog-to-digital converters, can be reduced with the aid of the storage means.

In a further advantageous embodiment, at least one frequency analyzing means can include at least one signal coupling region for coupling in electromagnetic signals. In this way, reliable coupling of the electromagnetic signals into the frequency analyzing means can be implemented.

At least one signal coupling region can advantageously be designed so that electromagnetic echo signals and electromagnetic scanning signals can be coupled in the same manner into the at least one frequency analyzing means. In this way, the electromagnetic echo signals and the electromagnetic scanning signals can be analyzed to form a common electromagnetic spectrum. The frequency profile of the echo signals and frequency profile of the scanning signals can thus be directly compared to one another. Distance variables can be determined more easily from the direct comparison of the frequency profiles of the echo signals and the scanning signals.

In a further advantageous embodiment, the receiving device can include at least one receiving variable determining means for determining at least one receiving variable for at least one detected object directly or indirectly from electrical signals which can be determined using the signal converting means. In this way, at least one distance variable for a detected object can be determined via the electrical signals which characterize the frequency profile of at least one electromagnetic echo signal.

Distance variables are variables which characterize the distance of an object to a defined reference point, in particular of the detection device.

In the case of a distance determination with the aid of a direct time-of-flight method, the time-of-flight between emitting and receiving the electromagnetic signals used for detecting an object can be used as a distance variable.

In the case of a distance determination with the aid of an indirect time-of-flight method, phase differences or frequency differences between an emitted signal, in particular an electromagnetic signal or an electrical signal generating the electromagnetic signal, and the received reflected signal, in particular the reflected electromagnetic signal or an electrical signal generated from the reflected electromagnetic signal, can be used as a distance variable. Variables characterizing phase differences or frequency differences can also be used as distance variables, in particular spatial intervals or interval variables characterizing these spatial intervals between spectral lines of a spectrum, in particular a frequency spectrum, of at least a part of the electromagnetic signals.

At least one distance variable determining means can advantageously include at least one correlation means. Using at least one correlation means, a correlation to those electrical signals determined using the signal converting means, in particular the digitized electrical signals, and at least one distance variable can be implemented. In this way, the at least one distance variable can be determined more easily from the electrical signals, in particular the digitized electrical signals.

At least one correlation means can advantageously include at least one correlation table. The correlations between the electrical signals, in particular the digitized electrical signals, and the corresponding distance variables can be stored beforehand in a correlation table, in particular at the end of a production process of the detection device. The correlation can be retrieved faster from a correlation table.

If both the electromagnetic echo signal and the electromagnetic scanning signal are coupled into the spectral analyzing means, the respective spectral line can thus be generated in a defined point in time in the frequency spectrum for each of the electromagnetic signals. Respective electrical signal maxima can be generated from the electromagnetic signals in the spectral lines using the two corresponding signal converting means, which correspond to the corresponding frequencies in the defined point in time. A difference frequency between the scanning signal and the echo signal can be determined directly from the correlation of these electrical signal maxima. Alternatively, the distance of the detected object can also be determined directly from the correlation of the participating two signal converting means with corresponding calibration.

Alternatively or additionally, at least one distance variable can be calculated from the electrical signals determined using the signal converting means or the digitized electrical signals. Correlation tables can be dispensed with in this way.

In a further advantageous embodiment, the receiving device can include at least one intensity determining means for determining an intensity variable, which characterizes an intensity of at least one electromagnetic signal introduced into the receiving device.

At least one intensity determining means can advantageously include addition means, using which the individual intensities of the electrical signals determined with the aid of the individual signal converting means, in particular the digitized electrical signals, can be added. The intensity variable can be determined easily in this way.

At least one intensity determining means can advantageously be functionally arranged after at least one digitizing means. In this way, the digitized electrical signals can be added using corresponding digital addition means.

Furthermore, the object is achieved according to the invention in the detection device in that at least one frequency analyzing means includes at least one spectral analyzing means, using which electromagnetic signals can be analyzed to form at least one electromagnetic spectrum, which can be output in at least one spectrum output region of the at least one spectral analyzing means,
at least two signal converting means, using which separate electrical signals can be ascertained, are assigned to different sections of at least one spectrum output region of the at least one spectral analyzing means,
wherein the different sections of at least one spectrum output region of the at least one spectral analyzing means correspond to different frequency ranges of at least one electromagnetic spectrum.

The detection device can advantageously be implemented at least partially as a one-chip system.

In addition, the object is achieved according to the invention in the vehicle in that at least one frequency analyzing means includes at least one spectral analyzing means, using which electromagnetic signals can be analyzed to form at least one electromagnetic spectrum, which can be output in at least one spectrum output region of the at least one spectral analyzing means,
at least two signal converting means, using which separate electrical signals can be ascertained, are assigned to different sections of at least one spectrum output region of the at least one spectral analyzing means,
wherein the different sections of at least one spectrum output region of the at least one spectral analyzing means correspond to different frequency ranges of at least one electromagnetic spectrum.

The vehicle can advantageously include at least one driver assistance system. Functions of the vehicle, for example driving functions or the like, in particular, can be operated autonomously or semi-autonomously using the at least one driver assistance system.

Advantageously, at least one detection device can be functionally connected to at least one driver assistance system. In this way, information about the monitoring region, in particular object information, such as distance, velocities, and/or directions of objects relative to the detection device, or relative to the vehicle, respectively, can be transmitted to the driver assistance system and can be used thereby to control the functions of the vehicle.

Furthermore, the object is achieved according to the invention in the method in that electromagnetic signals in at least one spectrum are analyzed using at least one spectral analyzing means,
the at least one spectrum is output in at least one spectrum output region of the at least one spectral analyzing means,
different ranges of the at least one electromagnetic spectrum are each converted using assigned signal converting means to form separate electrical signals.

According to the invention, electromagnetic signals, in particular scanning signals and/or echo signals, are analyzed in an electromagnetic spectrum. The electromagnetic spectrum is output in the spectrum output region of the spectral analyzing means. In the spectrum output region, the electromagnetic spectrum of a plurality of signal converting means, which are each assigned to one frequency range of the spectrum, is detected and converted into respective electrical signals. The frequency profiles of the electromagnetic signals, in particular the scanning signals and/or echo signals, are characterized using the electrical signals.

In one advantageous embodiment of the method, an electromagnetic scanning signal and the corresponding electromagnetic echo signal can be coupled into at least one spectral analyzing means and analyzed in at least one electromagnetic spectrum. In this way, the electromagnetic scanning signal and the electromagnetic reception signal can be compared to one another more easily via the electrical signals generated using the signal converting means.

If the electromagnetic scanning signal and therefore also the electromagnetic echo signal is an electromagnetic frequency-modulated continuous wave signal, a frequency difference between the scanning signal and the echo signal can be determined from the position of the signal converting means, in the range of which at a defined point in time the corresponding spectral lines of the scanning signal and the echo signal are located. A distance of a detected object can be determined from the frequency difference.

Moreover, the features and advantages disclosed in conjunction with the receiving device according to the invention, the detection device according to the invention, the vehicle according to the invention, and the method according to the invention and the respective advantageous embodiments thereof apply accordingly to one another and vice versa. The individual features and advantages may of course be combined with one another, wherein further advantageous effects that go beyond the sum of the individual effects may emerge.

### BRIEF DESCRIPTION OF THE DRAWINGS

Further advantages, features and details of the invention will become apparent from the following description, in which exemplary embodiments of the invention are explained in greater detail with reference to the drawing. A person skilled in the art will expediently also consider individually the features that have been disclosed in combination in the drawing, the description and the claims and will combine them to form meaningful further combinations. Schematically, in the figures,

FIG. 1 shows a vehicle in the front view having a driver assistance system and a LiDAR system for monitoring a monitoring region 13 in the travel direction in front of the vehicle;

FIG. 2 shows a functional representation of the LiDAR system from FIG. 1;

FIG. 3 shows a frequency-time diagram of an electromagnetic scanning signal by way of example in the form of a frequency-modulated continuous wave signal of the LiDAR system from FIGS. 1 and 2 for monitoring the monitoring region and a corresponding electromagnetic echo signal of the reflected scanning signal;

FIG. 4 shows a detail of the frequency-time diagram from FIG. 3, with a scanning sequence of the electromagnetic scanning signal and a corresponding echo sequence of the electromagnetic echo signal, wherein respective frequency ranges of the frequency spectrum of the electromagnetic signals are marked on the frequency axis, which are each mapped in a spectrum section of a spectrum output region of a spectroscope of the LiDAR system from FIG. 2;

FIG. 5 shows a frequency spectrum of the electromagnetic scanning signal and the electromagnetic echo signal from FIG. 4 in the spectrum output region of the spectroscope at a point in time T.

In the figures, identical components are provided with identical reference signs.

### EMBODIMENT(S) OF THE INVENTION

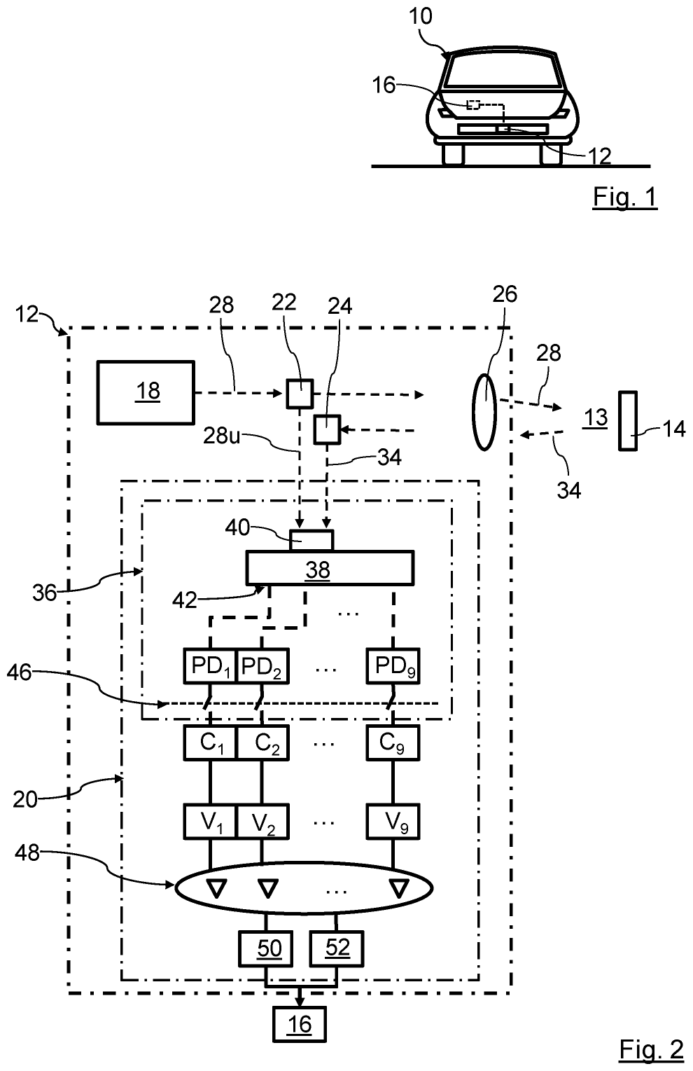

FIG. 1 shows a front view of a vehicle 10 by way of example in the form of a passenger vehicle.

The vehicle 10 has a detection device by way of example in the form of a LiDAR system 12. By way of example, the LiDAR system 12 is arranged in the front fender of the vehicle 10. A monitoring region 13 in front of the vehicle 10 in the travel direction can be monitored for objects 14 using the LiDAR system 12. The LiDAR system 12 can also be arranged at another location on the vehicle 10 and oriented differently. Using the LiDAR system 12, object information, for example distances, directions, and velocities of objects 14 relative to at least one reference region of the vehicle 10 and/or the LiDAR system 12, for example a longitudinal axis or a transverse axis of the vehicle 10, can be determined. For example, the directions of objects can be specified as azimuth and/or elevation.

The objects 14 may be stationary or moving objects, for example other vehicles, persons, animals, plants, obstacles, roadway irregularities, for example potholes or rocks, roadway boundaries, traffic signs, free spaces, for example parking spaces, precipitation or the like.

The LiDAR system 12 is designed by way of example as a frequency-modulated continuous-wave LiDAR system. Frequency-modulated continuous wave LiDAR systems are also referred to in specialist circles as FMCW-LiDAR systems. Distances of objects 14 can be determined using the LiDAR system 12 according to a time-of-flight method (TOF method).

The LiDAR system 12 is connected to a driver assistance system 16. The driver assistance system 16 can be used to operate the vehicle 10 autonomously or semiautonomously.

The LiDAR system 12 is designed, for example, as a so-called one-chip system, in which a large part of the components are implemented on one chip. For example, a part of the structures of the LiDAR system 12 can be integrated on a silicon optical chip (SoC). Alternatively, the LiDAR system 12 can also be implemented in another way.

The LiDAR system 12 is shown in a functional representation in FIG. 2. The LiDAR system 12 comprises an emitting device 18, a receiving device 20, a beam splitter 22, a beam deflector 24, and a lens 26.

The emitting device 18 comprises signal generating means, using which electrical emission signals can be generated, for example, in the form of frequency-modulated continuous wave signals. An electrical emission signal comprises a plurality of successive emission sequences, for example, in the form of frequency ramps.

An electromagnetic signal source of the emitting device 18 can be activated using the electrical emission signals, so that it emits corresponding electromagnetic scanning signals 28, for example, in the form of laser pulses into the monitoring region 13. The emitting device 18 can include one or more lasers as the electromagnetic signal source, for example.

The electromagnetic scanning signals 28 are frequency-modulated continuous wave signals, like the generating electrical emission signals. An electromagnetic scanning signal 28 comprises a plurality of successive scanning sequences 30, for example, in the form of frequency ramps.

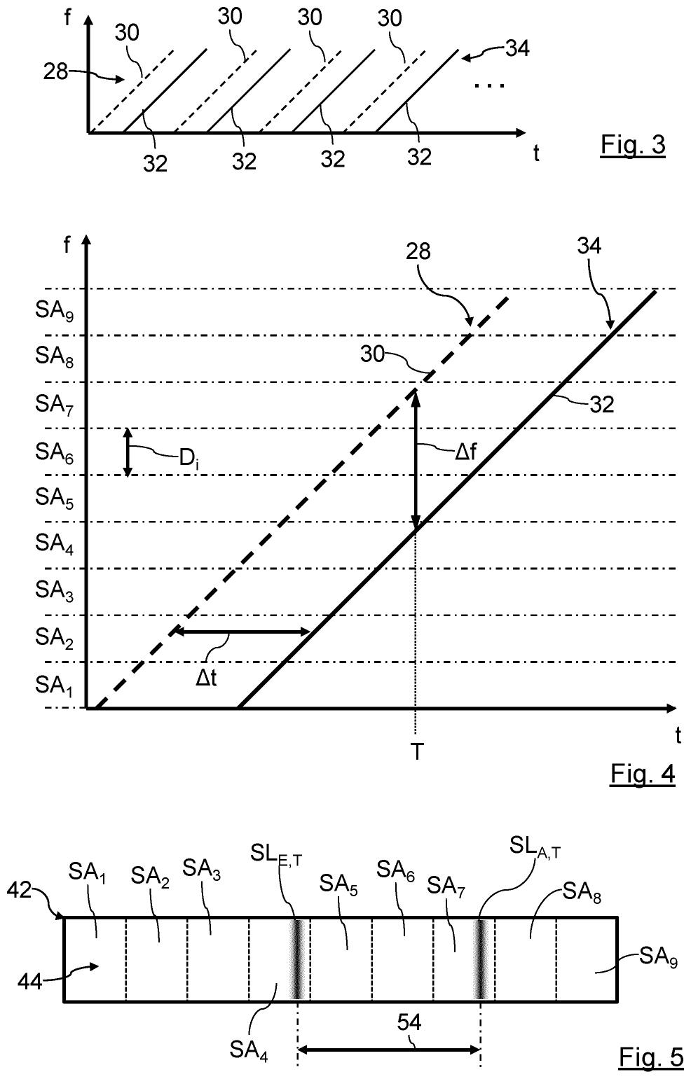

Several scanning sequences 30 of an electromagnetic scanning signal 28 are shown by dashed lines by way of example in a frequency-time diagram in FIG. 3, and corresponding echo sequences 32 of an electromagnetic echo signal 34 are shown for comparison. The electromagnetic echo signal corresponds to the electromagnetic scanning signals 28 reflected at an object 14.

FIG. 4 shows a detail of the frequency-time diagram with a scanning sequence 30 of the scanning signal 28 and the corresponding echo sequence 32 of the echo signal 34.

The beam splitter 22 is arranged in the beam path of the scanning signals 28 after the emitting device 18. A part of the scanning signals 28 is deflected toward the receiving device 20 using the beam splitter 22. The deflected part of the scanning signals 28 is designated by the reference sign “28u” in FIG. 2 for easier differentiability.

The lens 26 is arranged in the beam path of the scanning signals 28 after the beam splitter 22. Using the lens 26, the non-deflected part of the scanning signals 28 is formed, for example focused and/or expanded, and guided into the monitoring region 13.

In addition, echo signals 34 coming from the monitoring region 13 can be guided onto the beam deflector 24 using the lens 26. The beam deflector 24 is located in the beam path of the echo signals 34 between the lens 26 and the receiving device 20.

The beam deflector 24 can be designed, for example, as a prism, mirror, or the like. Using the beam deflector 24, the echo signals 34 can be deflected to the receiving device 20.

The receiving device 20 has a frequency analyzing means 36. Using the frequency analyzing means 36, the echo signals 34 and the deflected scanning signals 28u can be analyzed with respect to their frequency. The frequency analyzing means 36 comprises a spectral analyzing means, for example, in the form of a spectroscope 38, and a plurality of signal converting means, for example, in the form of photodiodes PD. Using the photodiodes PD, electromagnetic signals can be converted into electrical signals.

For example, the receiving device 20 in the example described in the figures only includes 9 photodiodes PD₁ to PD₉ for better clarity. In practice, significantly more photodiodes, for example several hundred photodiodes, are used to achieve a corresponding resolution in the determination of the distance variables.

The reference signs of the components respectively assigned to the photodiodes PD₁ to PD₉ are each also provided with indices between 1 and 9 hereinafter for easier assignment.

The spectroscope 38 has a signal coupling region 40 and a spectrum output region 42. In the signal coupling region 40, the echo signals 34 and the deflected scanning signals 28u are introduced so that they are uniformly subjected to a frequency analysis. Using the spectroscope 38, the echo signals 34 and the deflected scanning signals 28u are each separated here with respect to their wavelength, thus their frequency. The frequency spectrum 44 determined from the echo signals 34 and the deflected scanning signals 28u is output in the spectrum output region 42. In FIG. 5, the frequency spectrum 44 of a scanning signal 28u and an echo signal 34 at a point in time T is shown by way of example.

The spatial extension of the spectrum output region 42 in the direction of the frequency resolution is adapted to the maximum bandwidth of frequencies of the scanning signals 28 and the echo signals 34. The spatial extension of the spectrum output region 42 is at least sufficiently large here that all possible frequencies of the scanning signals 28 and the echo signals 34 can be output.

Each of the photodiodes PD₁ to PD₉ is assigned to a corresponding spectrum section SA₁ to SA₉ of the spectrum output region 42. The nine spectrum sections SA₁ to SA₉ are shown by way of example in FIG. 5. The photodiodes PD₁ to PD₉ can convert the electromagnetic signals, for example in the form of spectral lines, from the spectrum sections SA₁ to SA₉ respectively assigned to them into respective electrical signals.

Furthermore, the frequency analyzing means 36 has a recording control means, for example, in the form of a trigger device 46. Using the trigger device 46, a recording starting time and a recording duration for the recording of the frequency spectrum 44 using the photodiodes PD₁ to PD₉ can be defined. The outputs of the photodiodes PD₁ to PD₉ can be switched simultaneously using the trigger device 46. Snapshots of the entire spectrum 44 can thus be carried out.

An electrical storage means, for example, in the form of an analog storage cell C₁ to C₉ is assigned to each photodiode PD₁ to PD₉. The analog storage cells C₁ to C₉ are arranged functionally after the trigger device 46 and are each connected to the output side of the corresponding photodiode PD₁ to PD₉. The electrical signals determined using the photodiodes PD₁ to PD₉ can be temporarily stored in the analog storage cells C₁ to C₉. A following signal transmission can thus be slowed.

A preamplifier V₁ to V₉ is arranged functionally after each analog storage cell C₁ to C₉. The respective electrical signals can be amplified using the preamplifiers V₁ to V₉. A signal-to-noise ratio can thus be improved.

Alternatively or additionally, corresponding preamplifiers can also be functionally arranged before the analog storage cells C₁ to C₉, for example between the photodiodes PD₁ to PD₉ and the analog storage cells C₁ to C₉. In this way, the electrical signals of the photodiodes PD₁ to PD₉ can be amplified before they reach the analog storage cells C₁ to C₉.

A digitizing device 48 is arranged functionally after the preamplifiers V₁ to V₉. The preamplified analog electrical signals of the photodiodes PD₁ to PD₉ can be digitized using the digitizing device 48. The digitizing device 48 can include a plurality of analog-to-digital converters for this purpose, for example.

A distance variable determining means 50 is arranged functionally after the digitizing device 48. Using the distance variable determining means 50, a distance variable can be determined from the digital electrical signals which characterizes a distance of the object 14 detected using the LiDAR system 12 relative to the LiDAR system 12. The distance variable is, for example, a measure of the frequency difference Δf between the echo signal 34 and the deflected scanning signal 28u.

The distance variable determining means 50 includes correlation means, for example, in the form of a correlation table, using which the corresponding distance of the object 14 can be assigned to the distance variable. The correlation table can be determined beforehand, for example, in the scope of a calibration measurement, for example at the end of a production line, using the LiDAR system 12.

By way of example, combinations of photodiodes PD, which detect a scanning spectral line SL_{A}, described hereinafter, and a corresponding echo spectral line SL_{E} of the spectrum 44 at defined distances of an object 14 in a snapshot, can be correlated in the correlation table with the corresponding distances.

Furthermore, an optical intensity determining means 52 is arranged functionally after the digitizing device 48. The intensity of the echo signals 34 and the intensity of the deflected scanning signals 28u can be determined using the optical identity determining means 52 from the digital electrical signals of the individual photodiodes PD₁ to PD₉. For this purpose, the corresponding digitized individual signals of the photodiodes PD₁ to PD₉ can be combined again to form the respective overall signal.

The analog storage cells C₁ to C₉, the preamplifiers V₁ to V₉, the digitizing device 48, the distance variable determining means 50, and the optical identity determining means 52 are, for example, part of the receiving device 20.

The information determined using the receiving device 20, or the distance, the intensity of the echo signals 34, and the intensity of the deflected scanning signals 28u, can be transmitted via a corresponding connection to the driver assistance system 16.

To operate the LiDAR system 12, an electromagnetic scanning signal 28 is sent to the beam splitter 22 using the emitting device 18.

A part of the electromagnetic scanning signal 28 is split off using the beam splitter 22 and sent to the signal coupling region 40 of the spectroscope 38.

The part of the scanning signal 28 which is not split off passes through the lens 26 into the monitoring region 13. The scanning signal 28 is reflected at an object 14. The reflected echo signal 34 passes through the lens 26 to the beam deflector 24.

The echo signal 34 is guided into the signal coupling region 40 of the spectroscope 38 using the beam deflector 24.

A scanning sequence 30 of the deflected scanning signal 28u and an echo sequence 32 of the echo signal 34, as are supplied to the signal coupling region 40, are shown by way of example in a frequency-time diagram in FIG. 4.

Due to the time-of-flight between the emission of the scanning sequence 30 using the emitting device 18 and the reception of the echo sequence 32 using the receiving device 20, as shown in FIG. 4, the echo sequence 32 is shifted in relation to the scanning sequence 30 by the time-of-flight Δt. Since these are frequency-modulated continuous wave signals, in addition the frequency of the echo sequence 32 is shifted by the frequency difference Δf in relation to the frequency of the scanning sequence 30 at each point in time.

The deflected scanning signal 28u and the echo signal 34 are similarly analyzed with respect to their frequency using the spectroscope 38. The corresponding frequency spectrum 44 is output in the spectrum output region 42 of the spectroscope 38. The output frequency spectrum 44 is composed of the spectrum of the deflected scanning signal 28 and the spectrum of the echo signal 34. The spectrum 44 changes with time in accordance with the frequency-modulated signal profile of the scanning signal 28 and thus of the echo signal 34. Since both the deflected scanning signal 28u and the corresponding echo signal 34 are supplied to the same signal coupling region 40 of the receiving device 20 and analyzed in the same manner with respect to the frequency, the frequency spectra of the scanning signal 28u and the echo signal 34 can be directly compared in the one frequency spectrum 44.

FIG. 5 shows by way of example a snapshot of the frequency spectrum 44 at the point in time T. The frequency spectrum 44 includes, for example, a scanning spectral line SL_{A, T} and an echo spectral line SL_{E, T}. The scanning spectral line SL_{A, T} originates from the scanning signal 28u. The location of the scanning spectral line SL_{A, T} in the frequency spectrum 44 characterizes the frequency of the scanning signal 28u at the point in time T. The scanning spectral line SL_{E, T} originates from an echo signal 34. The location of the scanning spectral line SL_{A, T} in the frequency spectrum 44 characterizes the frequency of the echo signal 34 at the point in time T.

A spatial line distance 54 between the scanning spectral line SL_{A, T} and the echo spectral line SL_{E, T} on the spectrum arrival side 42 is a measure of the frequency difference Δf between the deflected scanning signal 28u and the echo signal 34. The frequency difference Δf and thus the line distance 54 correlate with the distance of the object 14 from the LiDAR system 12.

The signal components of the spectrum 44 in the corresponding spectrum sections SA₁ to SA₉ are detected and each converted into electrical signals using the photodiodes PD₁ to PD₉. The electrical signals are applied at the outputs of the photodiodes PD₁ to PD₉.

By appropriate activation using the trigger device 46, the electrical signals at the outputs of the photodiodes PD₁ to PD₉ are read simultaneously and transmitted to the corresponding analog storage cells C₁ to C₉. The snapshot of the spectrum 44, for example, at the point in time T is applied in the form of electrical signals in the analog storage cells C₁ to C₉. In the snapshot shown in FIG. 5, the echo spectral line SL_{E, T} is detected using the photodiode PD₄ and the scanning spectral line SL_{A, T} is detected using the photodiode PD₇.

The electrical signals are supplied from the analog storage cells C₁ to C₉ to the respective preamplifiers V₁ to V₉ and amplified using them.

The amplified electrical signals are then digitized using the digitizing device 48.

The digital amplified electrical signals are supplied to the distance variable determining means 50. Since the positions of the photodiodes PD₁ to PD₉ are assigned in a defined manner to the spectrum sections SA₁ to SA₉, the distance is determined from the combination of the photodiodes PD, in the example the photodiode PD₄ and the photodiode PD₇ which detect the scanning spectral line SL_{A, T} and the echo spectral line SL_{E, T}.

Furthermore, the amplified digital electrical signals of all photodiode branches are supplied to the optical intensity determining means 52. The digital electrical signals are combined using the optical intensity determining means 52. The intensities of the scanning signals 28u and the echo signals 34 are determined from the combination.

The distance variables and the intensities are transmitted to the driver assistance system 16. The vehicle 10 is operated at least semi-autonomously using the driver assistance system 16.

1. A receiving device of a detection device for monitoring at least one monitoring region for objects by electromagnetic scanning signals, comprising:
at least one signal converting means for converting electromagnetic signals, which originate from electromagnetic scanning signals, into electrical signals;
at least one frequency analyzing means for analyzing the frequency of signals,
wherein at least one frequency analyzing means includes at least one spectral analyzing means, using which electromagnetic signals is analyzed to form at least one electromagnetic spectrum, which is output in at least one spectrum output region of the at least one spectral analyzing means; and
at least two signal converting means, using which separate electrical signals can be determined, are assigned to different sections of at least one spectrum output region of the at least one spectral analyzing means,
wherein the different sections of at least one spectrum output region of the at least one spectral analyzing means correspond to different frequency ranges of at least one electromagnetic spectrum.

2. The receiving device as claimed in claim 1, wherein at least one spectral analyzing means includes at least one spectral apparatus.

3. The receiving device as claimed in claim 1, wherein at least one signal converting means includes at least one electro-optical component, using which electromagnetic signals can be converted into electrical signals.

4. The receiving device as claimed in claim 1, wherein at least one frequency analyzing means includes at least one recording control means, using which a respective recording starting point in time and/or a respective recording duration can be controlled for at least a part of the signal converting means.

5. The receiving device as claimed in claim 1, wherein the receiving device includes at least one storage means for storing at least a part of the electrical signals determined using the signal converting means.

6. The receiving device as claimed in claim 1, wherein the receiving device includes at least one amplifying means for amplifying at least a part of the electrical signals determined using the signal converting means.

7. The receiving device as claimed in claim 1, wherein the receiving device includes at least one digitizing means for digitizing at least a part of the electrical signals determined using the signal converting means.

8. The receiving device as claimed in claim 1, wherein at least one frequency analyzing means includes at least one signal coupling region for coupling in electromagnetic signals.

9. The receiving device as claimed in claim 1, wherein the receiving device includes at least one receiving variable determining means for determining at least one receiving variable for at least one detected object directly or indirectly from electrical signals which can be determined using the signal converting means.

10. The receiving device as claimed in claim 1, wherein the receiving device includes at least one intensity determining means for determining an intensity variable, which characterizes an intensity of at least one electromagnetic signal introduced into the receiving device.

11. A detection device for monitoring at least one monitoring region for objects by electromagnetic scanning signals, comprising:
at least one emitting device for emitting electromagnetic scanning signals into at least one monitoring region;
at least one receiving device, which includes at least one signal converting means for converting electromagnetic signals, which originate from electromagnetic scanning signals, into electrical signals;
at least one frequency analyzing means for analyzing the frequency of signals,
wherein at least one frequency analyzing means includes at least one spectral analyzing means, using which electromagnetic signals is analyzed to form at least one electromagnetic spectrum, which can be output in at least one spectrum output region of the at least one spectral analyzing means; and
at least two signal converting means, using which separate electrical signals are determined, are assigned to different sections of at least one spectrum output region of the at least one spectral analyzing means,
wherein the different sections of at least one spectrum output region of the at least one spectral analyzing means correspond to different frequency ranges of at least one electromagnetic spectrum.

12. A vehicle comprising:
at least one detection device for monitoring at least one monitoring region for objects by electromagnetic scanning signals,
wherein the at least one detection device comprises at least one emitting device for emitting electromagnetic scanning signals into at least one monitoring region, and at least one receiving device,
wherein at least one receiving device includes at least one signal converting means for converting electromagnetic signals, which originate from electromagnetic scanning signals, into electrical signals, and at least one frequency analyzing means for analyzing the frequency of signals,
wherein the at least one frequency analyzing means includes at least one spectral analyzing means, using which electromagnetic signals are analyzed to form at least one electromagnetic spectrum, which is output in at least one spectrum output region of the at least one spectral analyzing means,
at least two signal converting means, using which separate electrical signals can be determined, are assigned to different sections of at least one spectrum output region of the at least one spectral analyzing means,
wherein the different sections of at least one spectrum output region of the at least one spectral analyzing means correspond to different frequency ranges of at least one electromagnetic spectrum.

13. A method for operating a detection device for monitoring at least one monitoring region for objects, the method comprising:
emitting at least one electromagnetic scanning signal into the at least one monitoring region using at least one emitting device;
converting electromagnetic echo signals from electromagnetic scanning signals reflected in the at least one monitoring region using at least one signal converting means of a receiving device into electrical signals;
subjecting the electromagnetic signals to a frequency analysis using at least one frequency analyzing means of the at least one receiving device; and
analying the electromagnetic signals in at least one spectrum using at least one spectral analyzing means,
wherein the at least one spectrum is output in at least one spectrum output region of the at least one spectral analyzing means, and
wherein different ranges of the at least one electromagnetic spectrum are converted using respective assigned signal converting means to form separate electrical signals.

14. The method as claimed in claim 13, wherein an electromagnetic scanning signal and the corresponding electromagnetic echo signal are coupled into at least one spectral analyzing means and analyzed in at least one electromagnetic spectrum.
